(19) United States
(12) Patent Application Publication
(10) Pub. No.: US 2006/0221291 A1
(43) Pub. Date: Oct. 5, 2006

(54) Display device and manufacturing method thereof with an improved seal between the panels

(76) Inventors: Wang-Su Hong, Gyeonggi-do (KR); Sang-Il Kim, Gyeonggi-do (KR); Jong-Hyun Seo, Seoul (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 11/325,777

(22) Filed: Jan. 4, 2006

(30) Foreign Application Priority Data
Mar. 29, 2005 (KR) 10-2005-0025953

(51) Int. Cl. G02F 1/1339

(52) U.S. Cl. 349/153

(57) ABSTRACT

A display device is presented. The display device includes first and second panels positioned substantially parallel to each other, a liquid crystal layer disposed between the first and second panels, and a sealant attaching the the first and second panels to each other and sealing in the liquid crystal layer between the two panels. A sealant portion of at least one of the first and second panels includes a rough surface, the sealant portion contacting to the sealant upon the attaching of the two panels. The rough surface in the sealant portion allows the formation of a seal between the panels that is strong enough to be is suitable for use with a flexible substrate (e.g., a plastic substrate).

### RELATED APPLICATION

The present application claims priority from Korean Patent Application No. 2005-0025953 filed on Mar. 29, 2005, the disclosure of which is hereby incorporated herein by reference in its entirety.

### BACKGROUND OF THE INVENTION

(a) Field of the Invention

The present invention relates to a display device and a manufacturing method thereof, and more particularly to a flexible liquid crystal display including a plastic substrate and a manufacturing method thereof.

(b) Description of Related Art

Of the different types of flat panel displays available in the market today, liquid crystal displays (LCDs) and organic light emitting displays (OLEDs) are the most widely used.

An LCD includes two panels provided with field-generating electrodes, such as pixel electrodes and a common electrode. The panels also include polarizers, and a liquid crystal (LC) layer is interposed between the panels. The LCD displays images by applying voltages to the field-generating electrodes to generate an electric field in the LC layer. The electric field determines orientations of the LC molecules in the LC layer and adjusts the polarization of incident light.

An organic light emitting display (OLED) is a self emissive display device, which displays images by exciting an emissive organic material to generate light. The OLED includes an anode (hole injection electrode), a cathode (electron injection electrode), and an organic light emission layer interposed therebetween. When the holes and the electrons are injected into the light emission layer, they are combined to emit light.

Because the liquid crystal display and the organic light emitting display include fragile and heavy glass substrates, they are not suitable for portability and large scale displays.

Accordingly, a display device using a substrate made from a material such as plastic that is flexible as well as light and strong has recently been developed.

When using a plastic substrate instead of a glass substrate, advantages of the plastic substrate such as superior portability, stability, and light weight compared to the glass substrate may be exploited. Furthermore, plastic substrate provides additional advantages for the LCD fabrication process, which typically involves a deposition process and a printing process for a flexible display device. For example, the flexible display using the plastic substrate may be manufactured by a roll-to-roll process rather than a general sheet unit process. The use of a roll-to-roll process allows a higher yield at a lower cost, effectively reducing the production cost.

When forming the flexible display device, the strength of the adhesive material holding the panels together should be good enough to prevent leakage of the liquid crystal even when the display device is bent. Thus, a method of forming a stronger seal between the two panels is desired.

### SUMMARY OF THE INVENTION

In one aspect, the invention is a display device that includes first and second panels positioned substantially parallel to each other, a liquid crystal layer disposed between the first and second panels, and a sealant sealing attaching the first and second panels to each other and sealing in the liquid crystal layer between the first and second panels. A sealant portion of at least one of the first and second panels includes a rough surface, the sealant portion contacting the sealant upon the attaching of the first and second panels.

The rough surface has a roughness of 20 nm to 100 nm.

The rough surface has the contact area larger than that of a smooth surface.The first and second panels may each include a flexible substrate.

The flexible substrate may include a plastic substrate.

The flexible substrate may further include a barrier coating layer and a hard coating layer formed on multiple sides of the plastic substrate.

In another aspect, the invention is a manufacturing method of a display device that includes preparing a rough surface on a first panel, depositing a sealant on one of the first panel and a second panel, attaching the first and second panels with the sealant to form an enclosed space, and injecting liquid crystal into the enclosed space to form a liquid crystal layer, wherein the sealant contacts the rough surface of the first panel.

The rough surface has a roughness of 20 nm to 100 nm.

The rough surface has the contact area larger than that of a smooth surface.

The rough surface of the first panel may be formed by Ar plasma treatment.

The preparing of the rough surface on the first panel rough may include aligning a shadow mask on the first panel, the shadow mask having a cut-out region corresponding to a portion on the first panel where the sealant is positioned.

The method may further include attaching the first and second panels on a first supporter and a second supporter, respectively, before preparing the rough surface on the first panel, and detaching the first and second supporters from the first and second panels, respectively, after the injection of the liquid crystal.

The first and second supporters may be made of glass.

The first and second panels may each include a flexible substrate.

The flexible substrate may include a plastic substrate.

The flexible substrate may further include a barrier coating layer and a hard coating layer formed on respective sides of the plastic substrate.

The barrier and hard coating layers may include SiO₂ and SiNₓ.

### BRIEF DESCRIPTION OF THE DRAWINGS

The present invention will become more apparent by describing embodiments thereof in detail with reference to the accompanying drawings, in which:

FIG. 1 is a perspective view of an LCD according to an embodiment of the present invention;

FIG. 2 is a layout view of a TFT array panel for an LCD according to an embodiment of the present invention;

FIG. 3 is a sectional view of an LCD shown in FIG. 1 including the TFT array panel and a common electrode panel taken along the line III-III′ shown in FIG. 2;

FIGS. 4, 6, 8, 10, and 12 are layout views of the TFT array panel for the LCD shown in FIGS. 2 and 3 in intermediate steps of a manufacturing method thereof according to an embodiment of the present invention;

FIG. 5 is a sectional view of an LCD including the TFT array panel shown in FIG. 4 taken along the line V-V′;

FIG. 7 is a sectional view of an LCD including the TFT array panel shown in FIG. 6 taken along the line VII-VII′;

FIG. 9 is a sectional view of an LCD including the TFT array panel shown in FIG. 8 taken along the line IX-IX′;

FIG. 11 is a sectional view of an LCD including the TFT array panel shown in FIG. 10 taken along the line XI-XI′;

FIG. 13 is a sectional view of an LCD including the TFT array panel shown in FIG. 12 taken along the line XIII-XIII′;

FIG. 14 is a sectional view of an LCD including the TFT array panel shown in FIG. 12 taken along the line XIII-XIII′ and illustrates the step following the step shown in FIG. 13;

FIGS. 15 to 18 are sectional views illustrating manufacturing steps of a common electrode panel according to an embodiment of the present invention; and

FIG. 19 is a sectional view of the step of combining a TFT array panel and a common electrode panel in a manufacturing method according to an embodiment of the present invention.

### DETAILED DESCRIPTION OF EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, region, or substrate is referred to as being “on” another element, it can be directly on the other element or intervening elements may also be present. In contrast, when an element is referred to as being “directly on” another element, there are no intervening elements present.

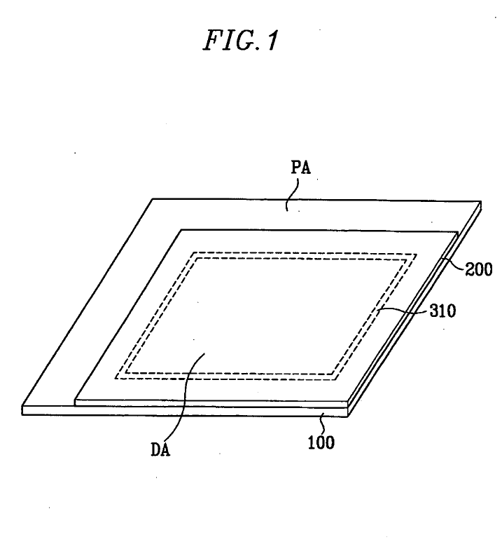

An LCD according to an embodiment of the present invention will be described in detail with reference to FIGS. 1 to 3.

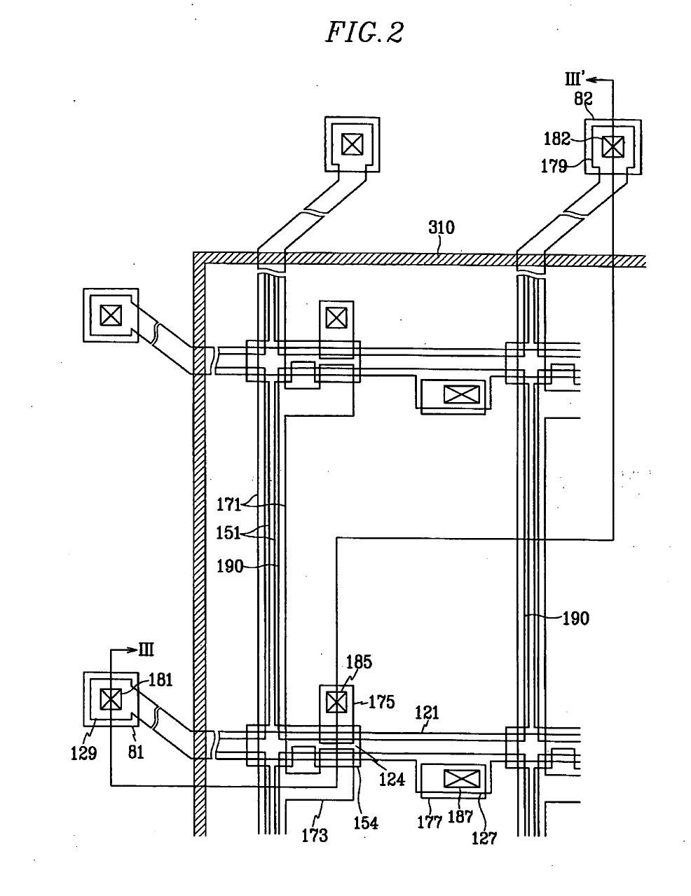

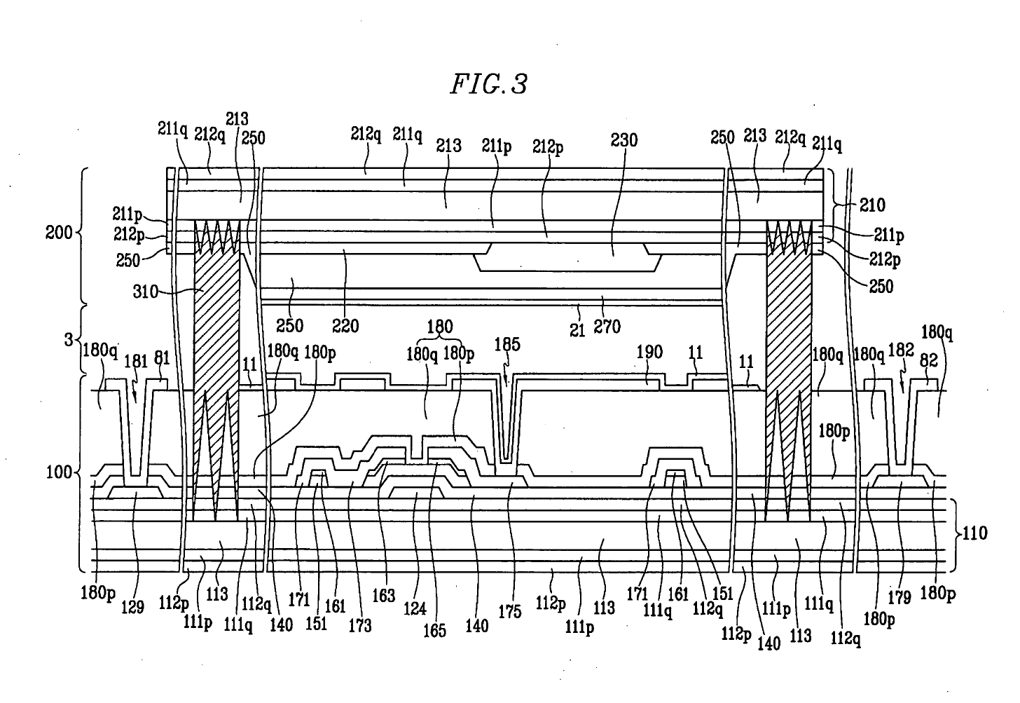

FIG. 1 is a perspective view of an LCD according to an embodiment of the present invention, FIG. 2 is a layout view of a TFT array panel for an LCD according to an embodiment of the present invention, and FIG. 3 is a sectional view of an LCD shown in FIG. 1 including the TFT array panel and a common electrode panel taken along the line III-III′ shown in FIG. 2.

An LCD according to an embodiment of the present invention includes a TFT array panel 100 and a common electrode panel 200 sandwiching an LC layer 3 and held together with a sealant 310.

As shown in FIG. 3, the sealant 310 attaches the panels 100 and 200 together. To achieve improved adhesion of the sealant to the panels, the urfaces where the sealant 310 contacts the panels 100 and 200 are preferably made rough.

The LC layer 3 shown in FIG. 3 may be arranged in a vertical mode or a twisted nematic mode, or may be arranged in a mode where the LC molecules are symmetrically bent with respect to the centers of the surfaces of the panels 100 and 200.

First, the common electrode panel 200 will be described with reference to FIG. 3.

Referring to FIG. 3, an upper insulating substrate 210 includes an insulating substrate 213 made of plastic, barrier coating layers 211p and 211q, and hard coating layers 212p and 212q. A barrier coating layer (211p or 211q) and a hard coating layer (212p and 212q) are sequentially formed on each surface of the insulating substrate 213.

The barrier coating layers 211p and 211q and the hard coating layers 212p and 212q are made of SiO₂ and SiNₓ, and play a role in preventing oxygen or moisture from penetrating into the upper substrate 210. Thus, the barrier coating layers 211p, 211q and the hard coating layers 212p, 212q help maintain the characteristics of the common electrode panel 200.

The insulating substrate 213 is made of a material selected from polyacrylate, polyethylene-terephthalate, polyethylene-naphthalate, polycarbonate, polyarylate, polyether-imide, polyethersulfone, and polyimides.

A light blocking member 220, which is often called a black matrix for preventing light leakage between pluralities of pixels, is formed on the upper insulating substrate 210. The light blocking member 220 may include a plurality of openings that face the pixels.

A plurality of color filters 230 are formed on the upper substrate 210 and they are disposed substantially in the areas enclosed by the light blocking member 220. The color filters 230 may extend along the pixel column. The color filters 230 may represent one of the primary colors such as red, green, and blue. The light blocking member 220 is formed by depositing the upper surface of an upper insulating substrate 210 with an opaque material having good light-blocking characteristic such as oxidized steel, carbon black, and Cr, Ni, Fe, or a metallic oxide thereof, and patterning the deposited material through photolithography using a photomask.

An overcoat 250 for preventing the color filters 230 from being exposed and for providing a flat surface is formed on the color filters 230 and the light blocking member 220. A common electrode 270, preferably made of a transparent conductive material such as ITO and IZO, is formed on the overcoat 250, and an alignment layer 21 is coated on the common electrode 270.

The surface of the sealant 310 extends from the overcoat 250 to the insulating substrate 213 through the barrier coating layer 211p. The sealant 310 is formed on portions of the common electrode panel 200 in a sawtooth shape, as shown in FIG. 3.

Next, the TFT array panel 100 is described in detail with reference to FIGS. 1 to 3.

The TFT array panel 100 includes a display area DA and a periphery area PA surrounding the display area DA. The sealant 310 is positioned just outside the boundary of the display area DA, on the periphery area PA.

A lower insulating substrate 110 includes an insulating substrate 113 made of plastic, barrier coating layers 111p and 111q, and hard coating layers 112p and 112q. A barrier coating layer (111p or 111q) and a hard coating layer (112p and 112q) are sequentially formed on each surface of the insulating substrate 113.

A plurality of gate lines 121 are formed on the insulating substrate 110.

The gate lines 121 transmit gate signals and extend substantially in a transverse direction. Each of the gate lines 121 includes a plurality of gate electrodes 124, projections 127 projecting downward, and an end portion 129 having a large area for contact with another layer or an external driving circuit. A gate driving circuit (not shown) for generating the gate signals may be mounted on a flexible printed circuit (FPC) film (not shown), which may be attached to the substrate 110, directly mounted on the substrate 110, or integrated onto the substrate 110. The gate lines 121 may extend to be connected to a driving circuit that may be integrated on the substrate 110.

The gate lines 121 are preferably made of an Al-containing metal such as Al and an Al alloy, an Ag-containing metal such as Ag and an Ag alloy, a Cu-containing metal such as Cu and a Cu alloy, a Mo-containing metal such as Mo and a Mo alloy, Cr, Ta, or Ti. In some embodiments, the gate lines 121 may have a multi-layered structure including two conductive films (not shown) having different physical characteristics. In these embodiments, one of the two films is preferably made of a low-resistivity metal including an Al-containing metal, an Ag-containing metal, or a Cu-containing metal for reducing signal delay or voltage drop. The other film is preferably made of a material such as a Mo-containing metal, Cr, Ta, or Ti, which has good physical, chemical, and electrical contact characteristics with other materials such as indium tin oxide (ITO) or indium zinc oxide (IZO). Examples of these multi-layered structure include a lower Cr film in combination with an upper Al (alloy) film and a lower Al (alloy) film in combination with an upper Mo (alloy) film. However, the gate lines 121 may be made of various metals or conductors other than the ones explicitly mentioned above.

The edges of the gate lines 121 are inclined relative to a surface of the substrate 110 to form an inclination angle of about 30-80 degrees.

A gate insulating layer 140, preferably made of silicon nitride (SiNx) or silicon oxide (SiOx), is formed on the gate lines 121.

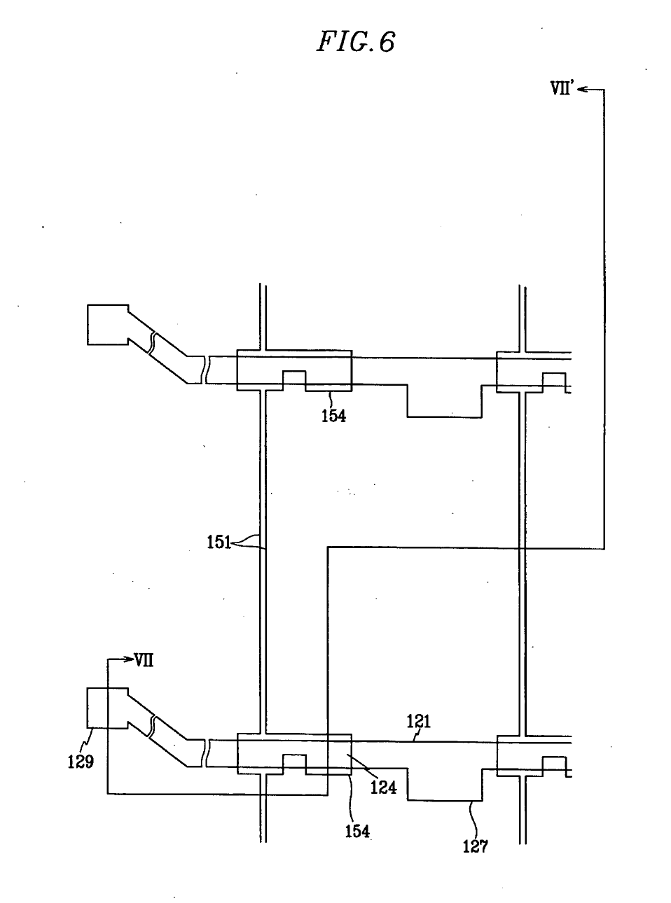

A plurality of semiconductor stripes 151 preferably made of hydrogenated amorphous silicon (abbreviated to “a-Si”) or polysilicon are formed on the gate insulating layer 140. Each of the semiconductor stripes 151 extends substantially in the longitudinal direction with respect to FIG. 6 and becomes wide near the gate lines 121 such that the semiconductor stripes 151 cover large areas of the gate lines. Each of the semiconductor stripes 151 includes a plurality of projections 154 projecting toward the gate electrodes 124.

A plurality of ohmic contact stripes and islands 161 and 165 are formed on the semiconductor stripes 151. The ohmic contact stripes and islands 161 and 165 are preferably made of n+hydrogenated a-Si heavily doped with N-type impurities such as phosphorus, or they may be made of a silicide. Each ohmic contact stripe 161 includes a plurality of projections 163, and the projections 163 and the ohmic contact islands 165 are located in pairs on the projections 154 of the semiconductor stripes 151.

The edges of the semiconductor stripes 151 and the ohmic contacts 161 and 165 are inclined relative to the surface of the substrate 110 to form inclination angles that are preferably in a range of about 30-80 degrees.

A plurality of data lines 171, a plurality of drain electrodes 175, and a plurality of storage capacitor conductors 177 are formed on the ohmic contacts 161 and 165 and the gate insulating layer 140.

The data lines 171 transmit data signals and extend substantially in the longitudinal direction with respect to FIG. 2 to intersect the gate lines 121. Each data line 171 includes a plurality of source electrodes 173 projecting toward the gate electrodes 124, and an end portion 179 having a large area for contact with another layer or an external driving circuit. A data driving circuit (not shown) for generating the data signals may be mounted on an FPC film (not shown), which may be attached to the substrate 110, directly mounted on the substrate 110, or integrated onto the substrate 110. The data lines 171 may extend to be connected to a driving circuit that may be integrated on the substrate 110.

As shown in FIG. 3, the drain electrodes 175 are separated from the data lines 171 and disposed across one of the gate electrodes 124 from the source electrodes 173.

A gate electrode 124, a source electrode 173, and a drain electrode 175 along with a projection 154 of a semiconductor stripe 151 form a TFT having a channel formed in the projection 154 disposed between the source electrode 173 and the drain electrode 175.

The storage capacitor conductors 177 overlap the projections 127 of the gate lines 121.

The data lines 171, the drain electrodes 175, and the storage capacitor conductors 177 are preferably made of a refractory metal such as Cr, Mo, Ta, Ti, or alloys thereof. However, they may have a multilayered structure including a refractory metal film (not shown) and a low-resistivity film (not shown). Examples of the multi-layered structure are a double-layered structure including a lower Cr/Mo (alloy) film and an upper Al (alloy) film and a triple-layered structure of a lower Mo (alloy) film, an intermediate Al (alloy) film, and an upper Mo (alloy) film. However, the data lines 171, the drain electrodes 175, and the storage capacitor conductors 177 may be made of various metals or conductors.

The data lines 171, the drain electrodes 175, and the storage capacitor conductors 177 have inclined edges that form inclination angles of about 30-80 degrees with respect to the surface of the gate insulating layer 140.

The ohmic contacts 161 and 165 are interposed only between the underlying semiconductor stripes 151 and the overlying conductors such as the data lines 171 and the drain electrodes 175, and reduce the contact resistance between the semiconductor stripes 151 and the conductors. Although the semiconductor stripes 151 are narrower than the data lines 171 at most places, the width of the semiconductor stripes 151 becomes large near the gate lines 121 as described above, to smooth the profile of the surface and thereby prevent disconnection of the data lines 171 from the semiconductor stripes 151.

As shown in FIG. 3, a passivation layer 180 is formed on the data lines 171, the drain electrodes 175, the storage capacitor conductors 177, and the exposed portions of the semiconductor stripes 151. The passivation layer 180 includes a lower passivation film 180p preferably made of an inorganic insulator such as silicon nitride or silicon oxide and an upper passivation film 180q preferably made of an organic insulator. The organic insulator preferably has a dielectric constant of less than about 4.0, and it may have photosensitivity and may provide a flat surface. The passivation layer 180 may have a single-layer structure preferably made of an inorganic or organic insulator.

The passivation layer 180 has a plurality of contact holes 182, 185, and 187 exposing the end portions 179 of the data lines 171, the drain electrodes 175, and the storage capacitor conductors 177, respectively. In addition, the passivation layer 180 and the gate insulating layer 140 have a plurality of contact holes 181 exposing the end portions 129 of the gate lines 121.

A plurality of pixel electrodes 190 and a plurality of contact assistants 81 and 82 are formed on the passivation layer 180. They are preferably made of a transparent conductor such as ITO or IZO, or a reflective conductor such as Ag, Al, Cr, or alloys thereof.

The pixel electrodes 190 are physically and electrically connected to the drain electrodes 175 through the contact holes 185 and to the storage capacitor conductors 177 through the contact holes 187 such that the pixel electrodes 190 receive data voltages from the drain electrodes 175. The pixel electrodes 190 supplied with the data voltages generate electric fields in cooperation with the common electrode 270 of the common electrode panel 200 supplied with a common voltage, which determine the orientations of LC molecules (not shown) of an LC layer 3 disposed between the two electrodes 190 and 270.

A pixel electrode 190 and the common electrode 270 form a capacitor referred to as a “liquid crystal capacitor,” which stores applied voltages after the TFT turns off. An additional capacitor called a “storage capacitor,” which is connected in parallel to the liquid crystal capacitor, is provided for enhancing the voltage storing capacity. The storage capacitors are implemented by overlapping the pixel electrodes 190 with the gate lines 121 adjacent thereto (called “previous gate lines”). The capacitances of the storage capacitors, i.e., the storage capacitances, are increased by providing the projections 127 at the gate lines 121 for increasing overlapping areas and by providing the storage capacitor conductors 177, which are connected to the pixel electrodes 190 and overlap the projections 127, under the pixel electrodes 190 for decreasing the distance between the terminals.

The pixel electrodes 190 overlap the gate lines 121 and the data lines 171 to increase the aperture ratio, but this is optional.

Each pixel electrode 190 may have a plurality of cutouts to change the orientations of the LC molecules.

In addition, each pixel electrode 190 may be divided into two or more sub-pixel electrodes (not shown). The sub-pixel electrodes may be capacitively coupled to each other through a coupling electrode (not shown), or connected to separate transistors (not shown).

The contact assistants 81 and 82 are connected to the end portions 129 of the gate lines 121 and the end portions 179 of the data lines 171 through the contact holes 181 and 182, respectively. The contact assistants 81 and 82 respectively protect the end portions 129 and 179 and enhance the adhesion between the end portions 129 and 179 and external devices.

An alignment layer 11 is formed on the pixel electrodes 190, contact assistants 81 and 82, and the passivation layer 180.

The surface of the sealant 310 is formed in a sawtooth pattern that extends from the upper passivation layer 180q to the insulating substrate 113. The sawtooth pattern extends through the barrier coating layer 111q.

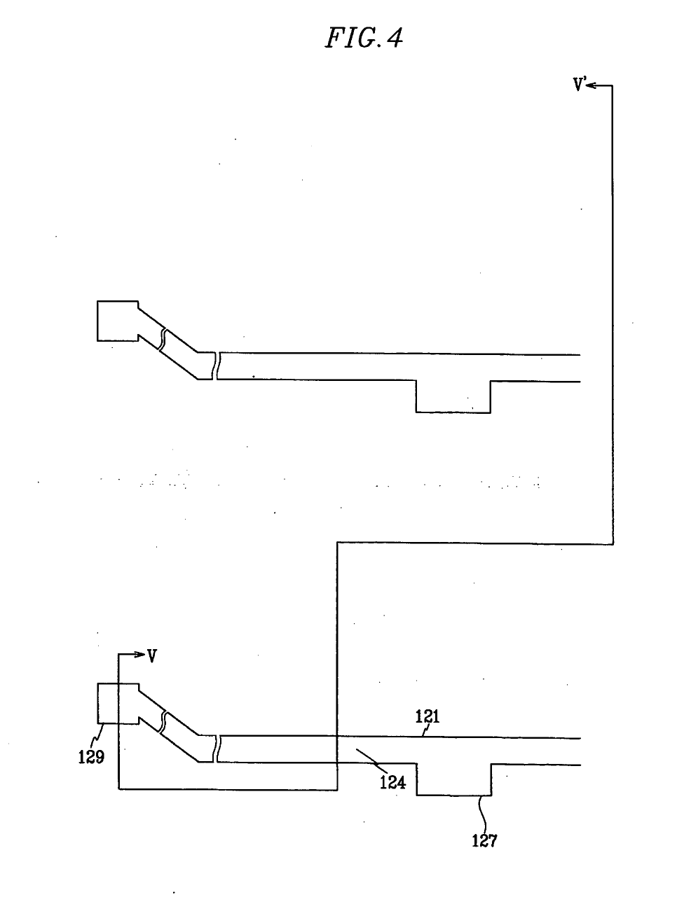

A method of manufacturing the TFT array panel shown in FIGS. 1 to 3 according to an embodiment of the present invention will be now described in detail with reference to FIGS. 4 to 14.

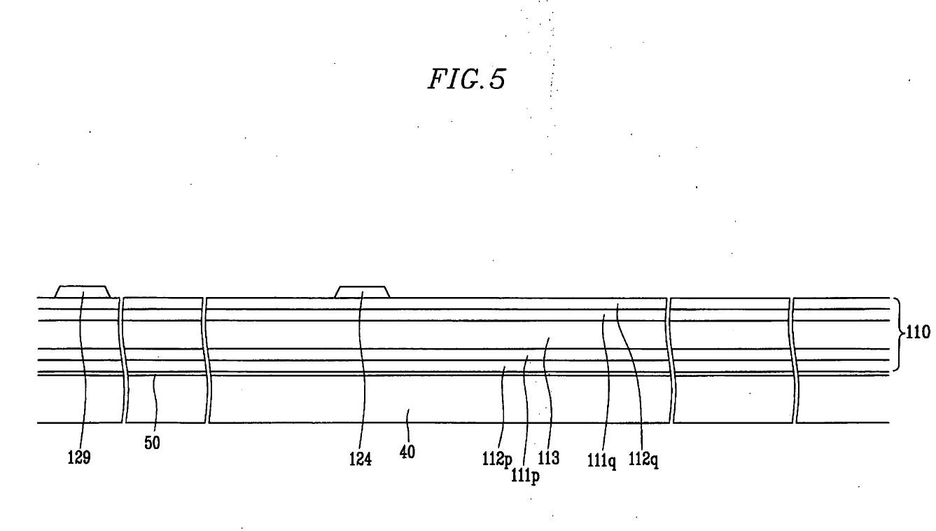

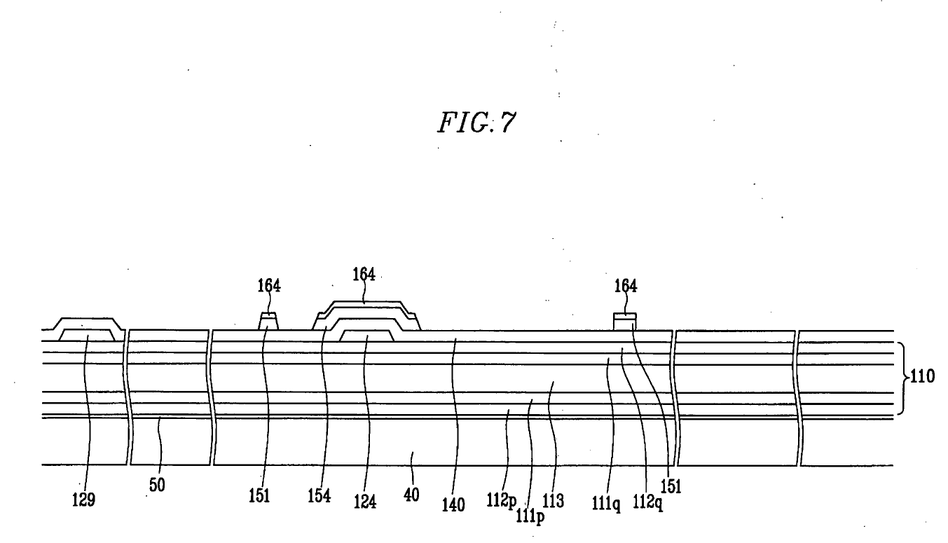

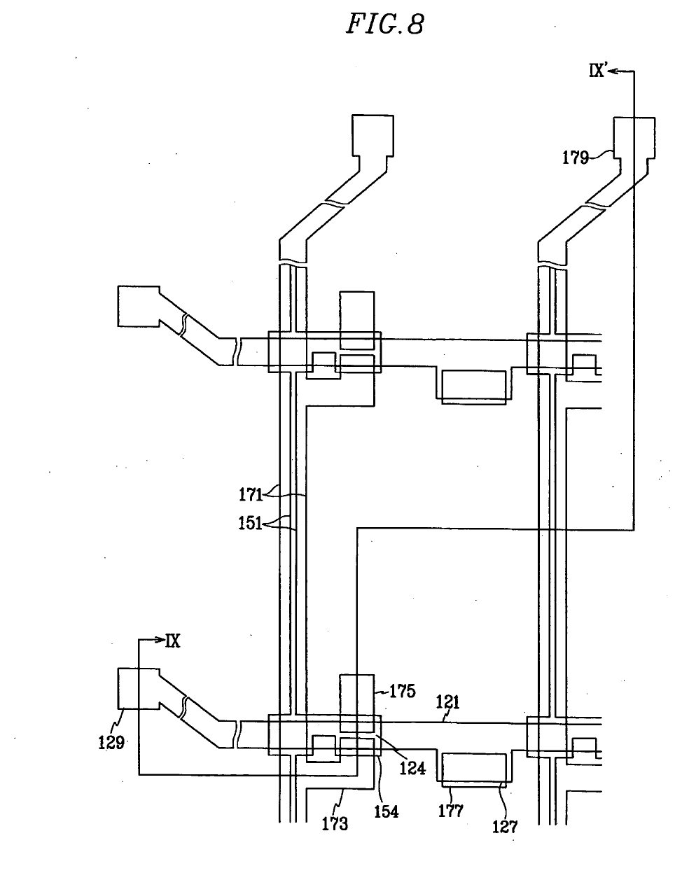

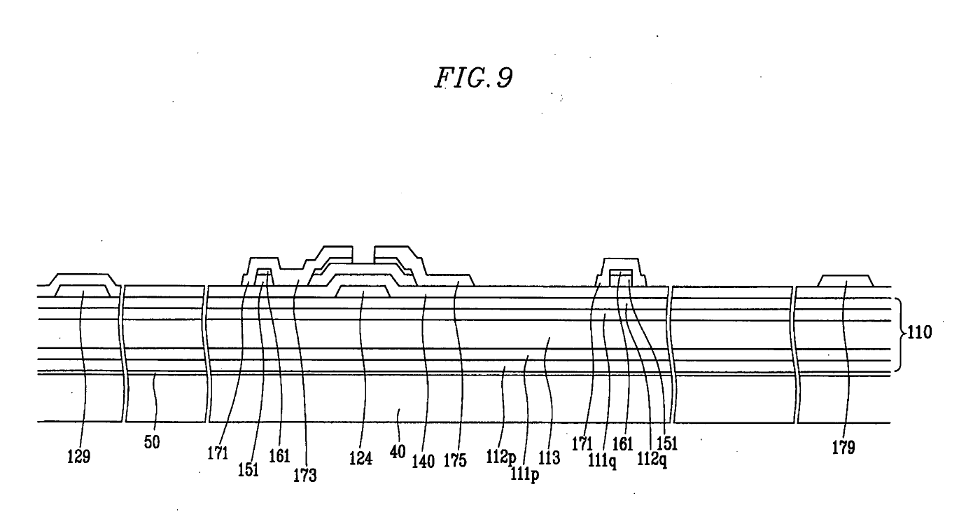

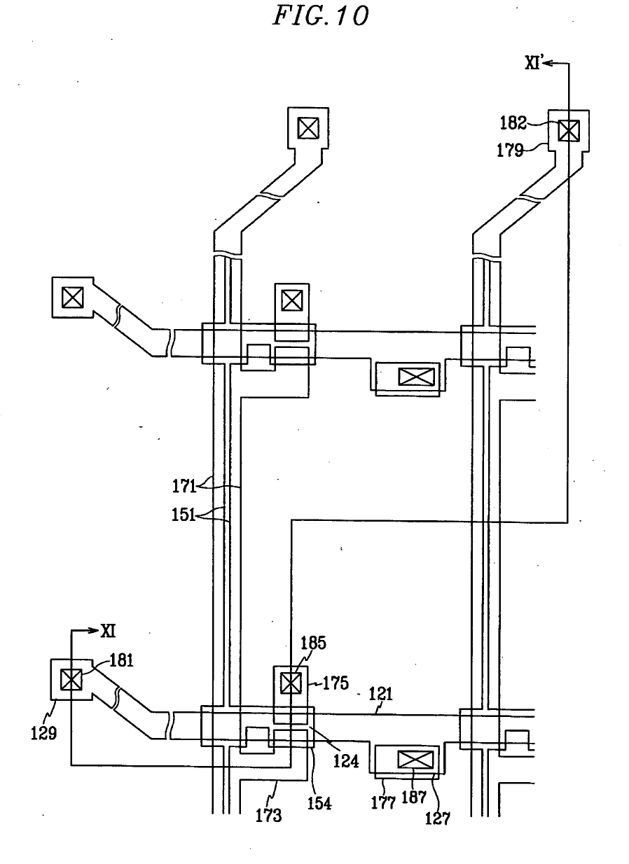

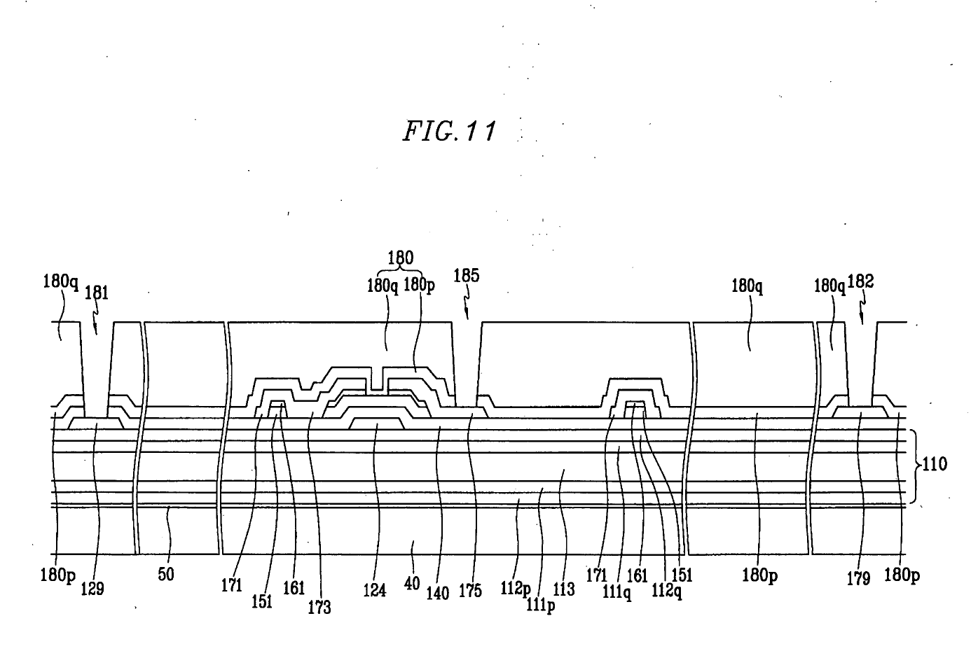

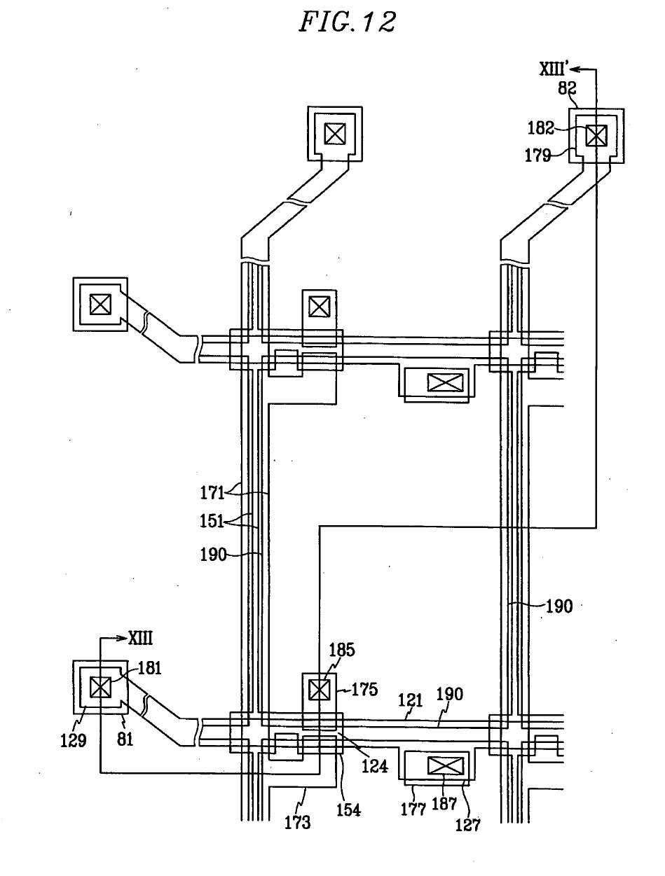

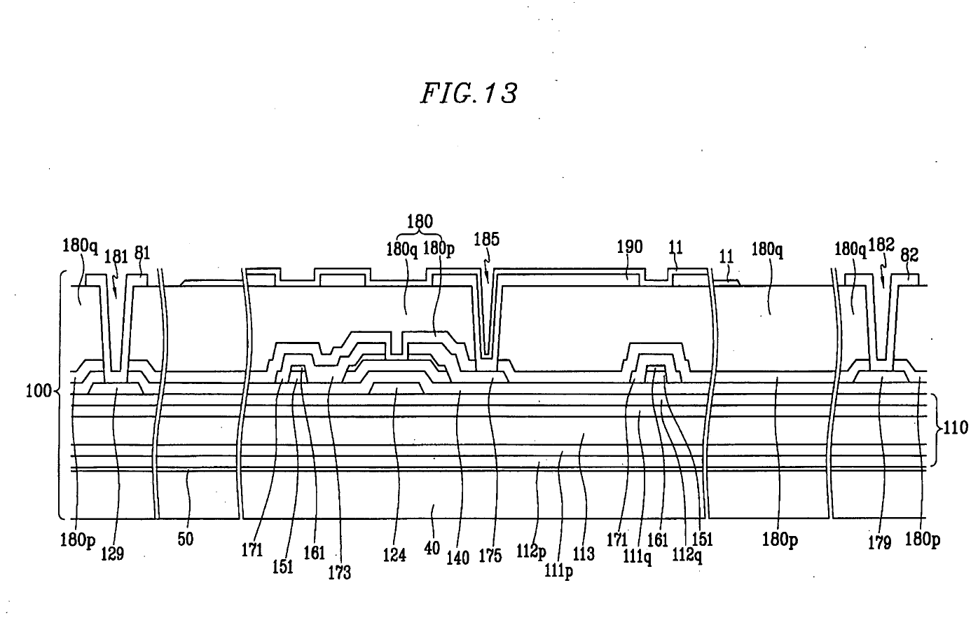

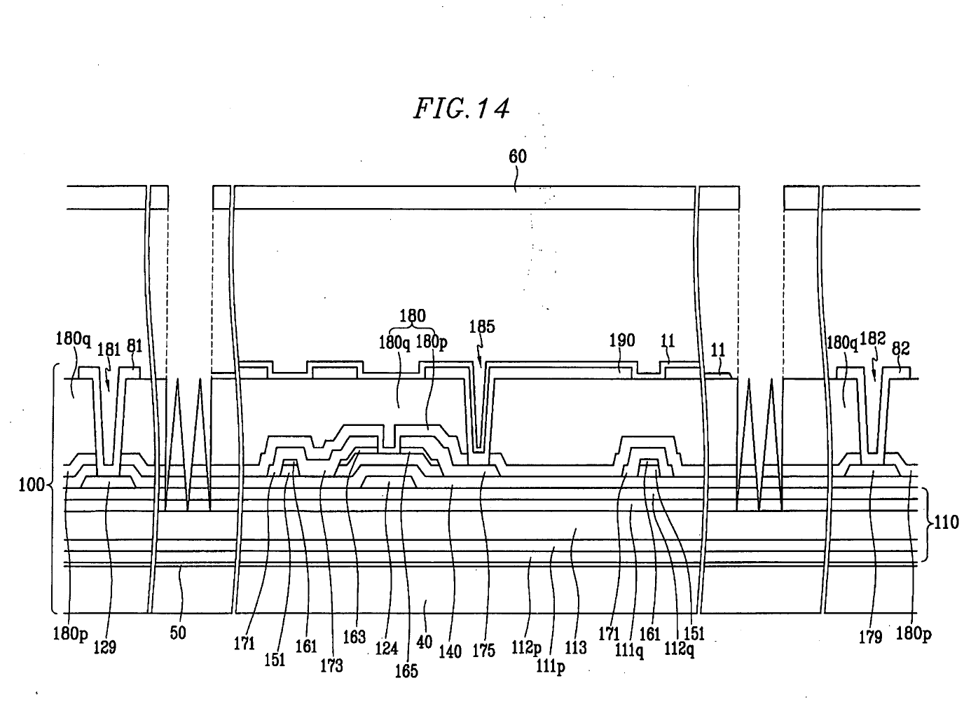

FIGS. 4, 6, 8, 10, and 12 are layout views of the TFT array panel for the LCD shown in FIGS. 2 and 3 in intermediate steps of a manufacturing method thereof according to an embodiment of the present invention, FIG. 5 is a sectional view of an LCD including the TFT array panel shown in FIG. 4 taken along the line V-V′, FIG. 7 is a sectional view of an LCD including the TFT array panel shown in FIG. 6 taken along the line VII-VII′, FIG. 9 is a sectional view of an LCD including the TFT array panel shown in FIG. 8 taken along the line IX-IX′, FIG. 11 is a sectional view of an LCD including the TFT array panel shown in FIG. 10 taken along the line XI-XI′, FIG. 13 is a sectional view of an LCD including the TFT array panel shown in FIG. 12 taken along the line XIII-XIII′, and FIG. 14 is a sectional view of an LCD including the TFT array panel shown in FIG. 12 taken along the line XIII-XIII′ and illustrates the step following the step shown in FIG. 13.

First, as shown in FIGS. 4 and 5, a lower insulating substrate 110 (such as a plastic substrate) is provided.

Next, one surface of a double-sided adhesive tape 50 made of a polyimide material is adhered on one surface of the lower insulating substrate 110, and the other surface of the adhesion tape 50 is adhered on one surface of a supporter 40 made of a transparent material such as glass to complete the combination of the lower insulating substrate 110 and the supporter 40.

As shown in FIGS. 4 and 5, a metal film is sputtered and patterned by photo-etching with a photoresist pattern on the lower insulating substrate 110 to form a plurality of gate lines 121 including a plurality of gate electrodes 124 and a plurality of projections 127.

Referring to FIGS. 6 and 7, after sequential deposition of a gate insulating layer 140, an intrinsic a-Si layer, and an extrinsic a-Si layer, the extrinsic a-Si layer and the intrinsic a-Si layer are photo-etched to form a plurality of extrinsic semiconductor stripes 164 and a plurality of intrinsic semiconductor stripes 151 including a plurality of projections 154 on the gate insulating layer 140.

Referring to FIGS. 8 and 9, a metal film is sputtered and etched using a photoresist to form a plurality of data lines 171 including a plurality of source electrodes 173, a plurality of drain electrodes 175, and a plurality of storage capacitor conductors 177.

Before or after removing the photoresist, portions of the extrinsic semiconductor stripes 164 that are not covered with the data lines 171, the drain electrodes 175, and the storage capacitor conductors 177 are removed by etching to complete a plurality of ohmic contact stripes 161 including a plurality of projections 163 and a plurality of ohmic contact islands 165 and to expose portions of the intrinsic semiconductor stripes 151. Oxygen plasma treatment may follow thereafter in order to stabilize the exposed surfaces of the semiconductor stripes 151.

Referring to FIGS. 10 and 11, a lower passivation layer 180p preferably made of an inorganic material such as silicon nitride or silicon oxide is formed by plasma enhanced chemical vapor deposition (PECVD), and an upper passivation layer 180q preferably made of photosensitive organic material is coated on the lower passivation layer 180p. Then, the upper passivation layer 180q is exposed to light through a photo mask and developed to expose the portion of the lower passivation layer 180p, and the exposed portion of the lower passivation layer 180p is dry etched along with the gate insulating layer 140 to form a plurality of contact holes 181, 182, 185, and 187.

Referring to FIGS. 12 and 13, a conductive layer preferably made of a transparent material such as ITO and IZO is deposited by sputtering and is etched using the photoresist to form a plurality of pixel electrodes 190 and a plurality of contact assistants 81 and 82. Sequentially, an alignment layer 11 is formed on the pixel electrodes 190 and the upper passivation layer 180q.

Next, referring to FIG. 14, a shadow mask 60 is aligned on the TFT array panel 100 manufactured by the processes of FIGS. 4 to 13. As shown in FIG. 1, portions of the shadow mask 60 corresponding to portions on which the sealant 310 surrounds the display area DA are formed are cut out. A surface of the lower substrate 110 becomes rough by Ar plasma treatment using the shadow mask 60. At this time, a surface roughness of the lower substrate 110 is about 20 nm to 100 nm.

The rough surface treatment of the lower substrate 110 may be accomplished by any suitable known physical or chemical treatments.

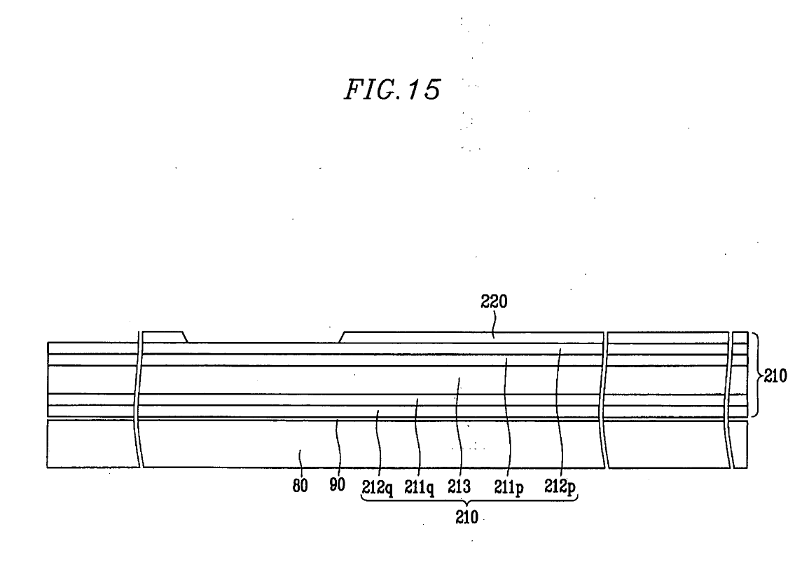

Now, a method of manufacturing the common electrode panel for the flexible LCD shown in FIGS. 1 to 3 will be described with reference to FIGS. 15-19.

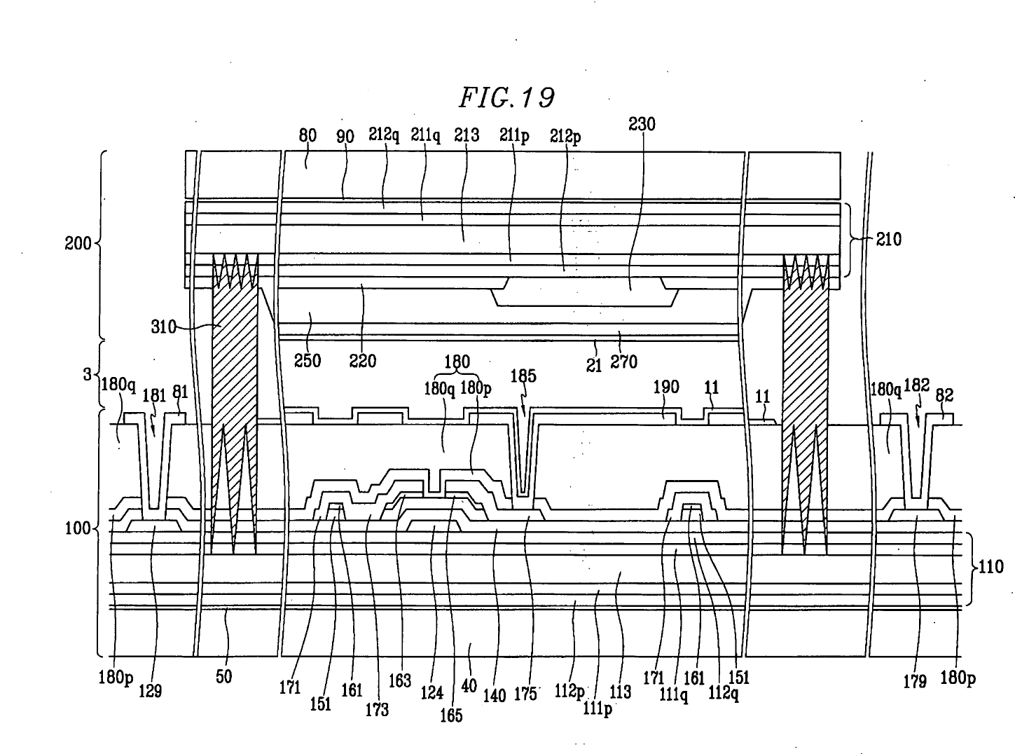

FIGS. 15 to 18 are sectional views illustrating manufacturing steps of a common electrode panel according to an embodiment of the present invention, and FIG. 19 is a sectional view of the step of combining a TFT array panel and a common electrode panel in a manufacturing method according to an embodiment of the present invention.

First, as shown in FIG. 15, an upper insulating substrate 210 made of a material such as plastic is provided.

Next, one surface of a double-sided adhesive tape 90 made of a polyimide material is adhered to one surface of the upper insulating substrate 210, and the other surface of the adhesive tape 90 is adhered to one surface of a supporter 80 made of a transparent material such as glass, to complete the combination of the upper insulating substrate 210 and the supporter 80.

A light blocking member 220 is formed by deposition on the upper surface of the upper insulating substrate 210.

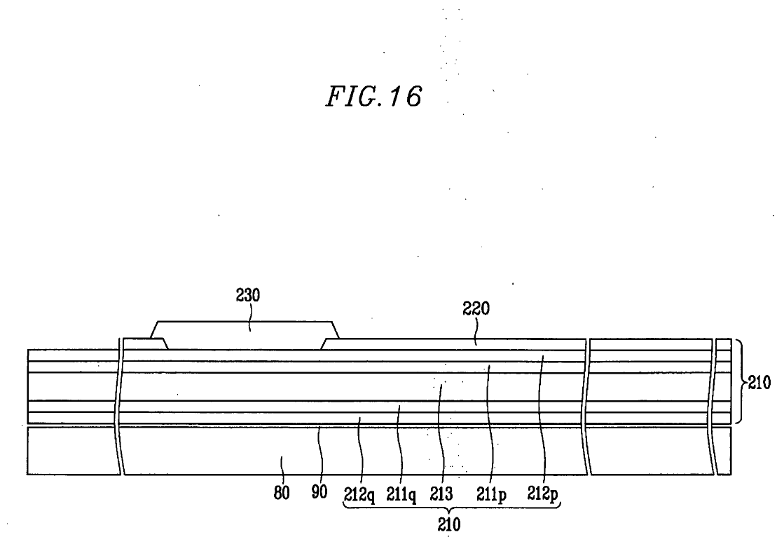

Referring to FIG. 16, the color filters 230 are formed on the upper insulating substrate 210. The color filters 230 of red, green, and blue colors are separated from each other and their edge portions extend over the edges of the light blocking member 220.

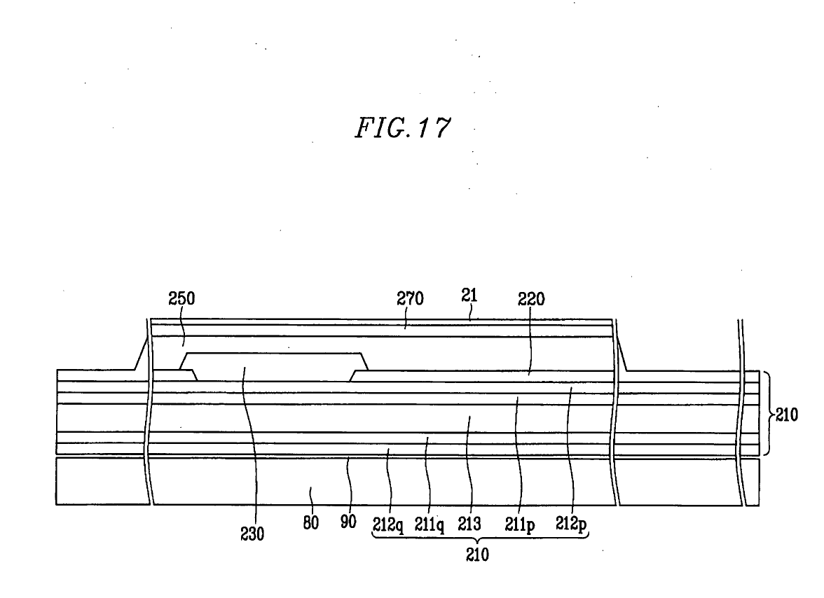

Referring to FIG. 17, an overcoat 250 preferably made of an acryl material is formed on the color filters 230 and the light blocking member 220 to enhance the step coverage characteristics of the overlying layer and the flatness of the surface of the common electrode panel 200.

Subsequently, an ITO or IZO layer is deposited on the overcoat 250 to form a common electrode 270, and an alignment layer 21 is coated thereon to form the common electrode panel 200.

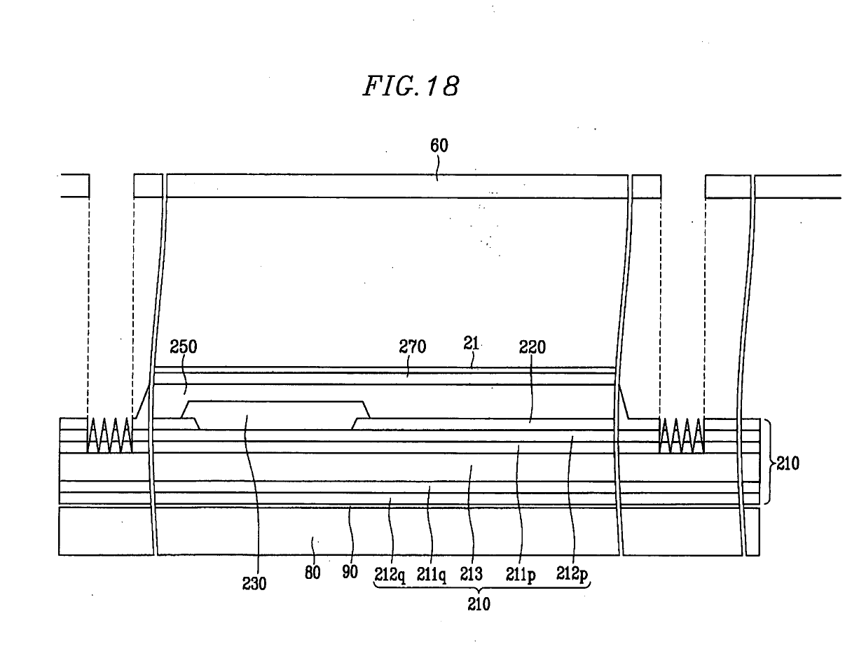

Next, referring to FIG. 18, a shadow mask 60 is aligned on the common electrode panel 200 manufactured by the processes of FIGS. 15 to 17. A surface of the upper substrate 210 becomes rough by Ar plasma treatment using the shadow mask 60 to form the common electrode 270. At this time, a surface roughness of the upper substrate 210 is about 20 nm to 100 nm. The rough surface treatment of the upper substrate 210 may be accomplished by any suitable physical or chemical treatments. Referring to FIG. 19, the TFT array panel 100 and the common electrode panel 200 are attached toe ach other by the sealant 310.

The sealant 310 is formed on the rough portions of the surface of the panels 100 and 200. The rough portions increase the contact area between the panels 100, 200 and the sealant 310 to improve the strength of the seal.

LC is injected between the panels 100 and 200 to form an LC layer 3.

A hot press process is executed at about 150° C. During this process, the lower and upper substrates 100 and 200 made of plastic are supported by the supporters 40 and 50 made of glass to prevent expansion or bending of the substrates 100 and 200.

Next, the supports 40 and 80 are removed from the TFT array panel 100 and the common electrode panel 200 of the LCD by reducing the adhesive strength of the adhesive tapes 50 and 90. of the adhesive strength of the adhesive tapes 50, 90 may be adjusted by controlling the temperature, using a solvent, or irradiating ultraviolet rays, etc. If the temperature is adjusted, the adhesive strength of the adhesion tapes 50 and 90 becomes sufficiently weak at a temperature of less than 0 degrees, allowing the supporters 40 and 80 to be removed from the TFT array panel 100 and the common electrode panel 200 to form the LCD as shown in FIG. 3.

Because the contact surfaces of the lower and upper insulating substrates and the sealant has the roughness of about 20 nm to 100 nm through the physical or chemical treatments, the contact area of the sealant with respect to the lower and upper insulating substrates becomes larger. Therefore, a better seal is achieved than if there were no rought surface, and the reliability of the LCD are improved. Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A I display device comprising:
first and second panels positioned substantially parallel to each other;
a liquid crystal layer disposed between the first and second panels; and
a sealant attaching the first and second panels to each other and sealing in the liquid crystal layer between the first and second panels,
wherein a sealant portion of at least one of the first and second panels includes a rough surface, the sealant portion contacting the sealant upon the attaching of the first and second panels.

2. The device of claim 1, wherein the rough surface has a roughness of 20 nm to 100 nm.

3. The device of claim 2, wherein the rough surface has the contact area larger than that of a smooth surface.

4. The device of claim 1, wherein the first and second panels each includes a flexible substrate.

5. The device of claim 4, wherein the flexible substrate includes a plastic substrate.

6. The device of claim 5, wherein the flexible substrate further includes a barrier coating layer and a hard coating layer formed on multiple sides of the plastic substrate.

7. A manufacturing method of a display device, comprising:
preparing a rough surface on a first panel;
depositing a sealant on one of the first panel and a second panel;
attaching the first panel to the second panel by the sealant to form an enclosed space; and
injecting liquid crystal into the enclosed space to form a liquid crystal layer,
wherein the sealant contacts the rough surface of the first panel.

8. The device of claim 7, wherein the rough surface has a roughness of 20 nm to 100 nm.

9. The device of claim 8, wherein the rough surface has the contact area larger than that of a smooth surface.

10. The method of claim 7, wherein the rough surface of the first panel is formed by Ar plasma treatment.

11. The method of claim 7, wherein the preparing of the rough surface comprises:
aligning a shadow mask on the first panel, the shadow mask having a cut-out region corresponding to a portion on the first panel where the sealant is positioned; and
treating a surface of the first panel using the shadow mask.

12. The method of claim 11, further comprising:
attaching the first and second panel on a first supporter and a second supporter, respectively, before the preparing of the rough surface on the first panel and
detaching the first and second supporters from the first and second panels, respectively, after the injection of the liquid crystal.

13. The method of claim 12, wherein the first and second supporters are made of glass.

14. The method of claim 7, wherein the first and second panels each include a flexible substrate.

15. The method of claim 14, wherein the flexible substrate includes a plastic substrate.

16. The method of claim 15, wherein the flexible substrate further includes a barrier coating layer and a hard coating layer formed on multiple sides of the plastic substrate.

17. The method of claim 15, wherein the barrier and hard coating layers include SiO₂ and SiNₓ.
